(19) United States
(12) Patent Application Publication
(10) Pub. No.: US 2012/0109581 A1
(43) Pub. Date: May 3, 2012

(54) DIAGNOSTIC SYSTEM AND METHOD FOR AN ESSENTIAL TURBINE VALVE

(75) Inventor: Meir REGAL, Doar Na Avtach (IL)

(73) Assignee: Ormat Technologies Inc., Reno, NV (US)

(21) Appl. No.: 12/914,524

(22) Filed: Oct. 28, 2010

(51) Int. Cl. G06F 15/00

(52) U.S. Cl. 702/183

(57) ABSTRACT

The present invention is a diagnostic method for determining the operability of an essential turbine valve, comprising the steps of exercising an essential valve operatively connected to a turbine inlet line through which a power plant motive fluid is supplied to a turbine by causing the essential valve to be partially closed for a predetermined exercising duration; detecting a drop in power produced by an electric generator coupled to the turbine resulting from said partial closing of the essential valve; comparing the detected power drop with a predetermined marginal power drop; and associating the essential valve with an operable status for reliably regulating the flow of motive fluid therethrough when the actual power drop is substantially equal to the predetermined marginal power drop.

The present invention relates to the field of diagnostic systems. More particularly, the invention relates to a diagnostic system and method for determining the operability of an essential turbine valve such as an injection valve.

A turbine converting the thermal energy of the motive fluid of a power plant into mechanical energy or electric power has a control system for regulating the flow of motive fluid into the turbine via an injection valve and for controlling the rotational speed of the turbine rotor, in response to the instantaneous load so that an optimal amount of power will be produced. The performance level of the power plant will be greatly affected if the injection valve will not respond quickly enough.

At times, due to the malfunctioning of a power plant component or of the turbine itself, the turbine has to be immediately tripped in order to prevent power plant damage. A turbine tripping event is generally initiated by actuating a turbine main open/close valve to prevent introduction of additional motive fluid into the turbine. Irreversible damage can be caused to the power plant if this open/close valve will not respond quickly enough.

Many valve diagnostic systems are known in the prior art; however, they are sophisticated and require costly equipment to be installed and to be maintained, or alternatively require trained specialists to collect, process and analyze the data.

It would be therefore desirable for the present invention to provide a reliable diagnostic system and method for determining the operability of an essential turbine valve.

In addition, the present invention provides a diagnostic system for determining the operability of an essential turbine valve which is inexpensive to install and to maintain.

Other advantages of the invention will become apparent as the description proceeds.

The present invention is a diagnostic method for determining the operability of an essential turbine valve, comprising the steps of exercising an essential valve operatively connected to a turbine inlet line through which a power plant motive fluid is supplied to a turbine by causing said essential valve to be partially closed for a predetermined exercising duration; detecting a drop in power produced by an electric generator coupled to said turbine resulting from said partial closing of said essential valve; comparing said detected power drop with a predetermined marginal power drop; and associating said essential valve with an operable status for reliably regulating the flow of motive fluid therethrough when said actual power drop is substantially equal to said predetermined marginal power drop.

In one aspect, the essential valve having an operable status, which may be an injection valve or a main open/close valve, undergoes an additional e.g. weekly diagnostic test to continuously ensure valve reliability.

In a further aspect, an essential valve that has failed a diagnostic test is associated with a fault status and undergoes e.g. a daily diagnostic test. The status of an essential valve may be set to a fault status when the actual power drop is less than a predetermined minimum power drop, or when the actual power drop exceeds the predetermined marginal power drop by more than a predetermined difference.

The present invention is also directed to a diagnostic system for determining the operability of an essential turbine valve, comprising an essential valve operatively connected to a turbine inlet line through which a power plant motive fluid is supplied to a turbine, a valve controller in electric communication with an actuator of said essential valve, a sensor for detecting the power output of an electric generator coupled to said turbine, and a computing device in data communication with said sensor and with said controller, wherein said computing device is operable to send control signals to said controller to initiate an exercising operation with respect to said essential valve which induces a drop in power produced by said electric generator, to compare data received from said sensor related to an actual power drop induced by said exercising operation with a predetermined marginal power drop, and to associate said essential valve with an operable status for reliably regulating the flow of motive fluid therethrough when said actual power drop is substantially equal to said predetermined marginal power drop.

In the drawings:

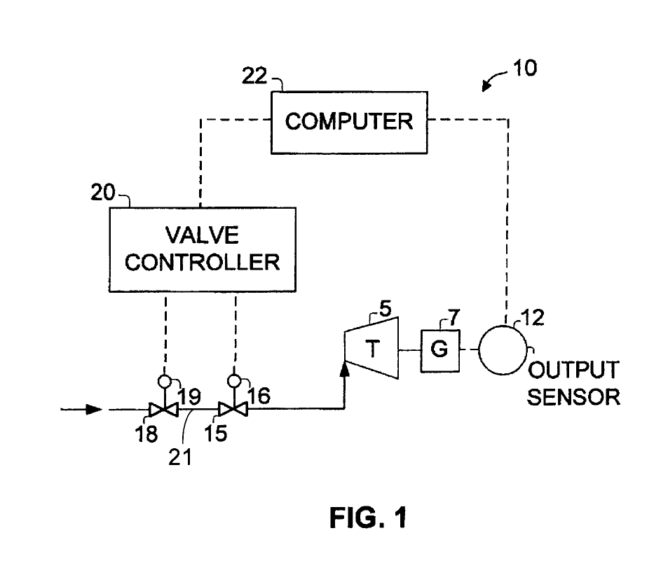

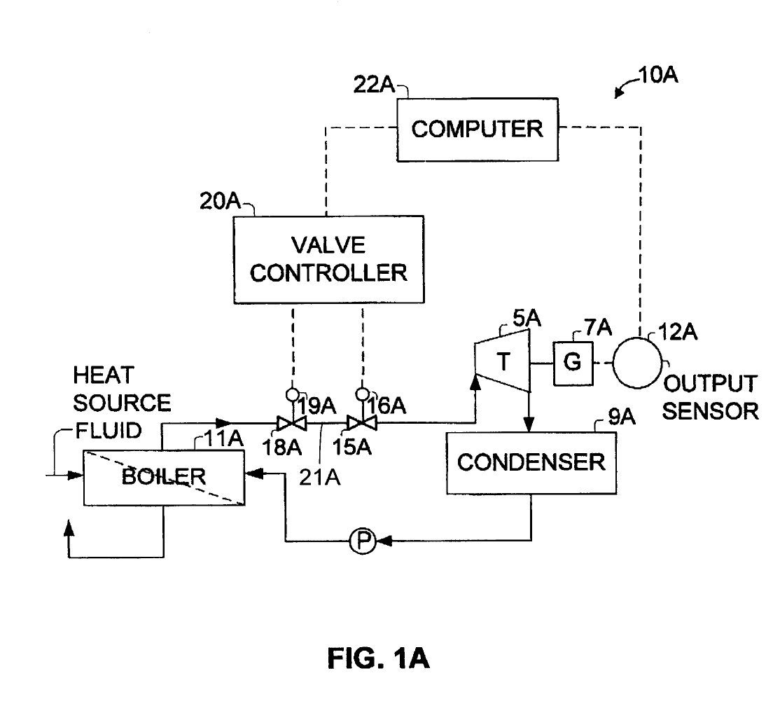

FIG. 1 is a schematic illustration of a diagnostic system for determining the operability of an essential turbine valve, according to one embodiment of the present invention;

FIG. 1A is a schematic illustration of a diagnostic system for determining the operability of an essential turbine valve, according to a further embodiment of the present invention; and

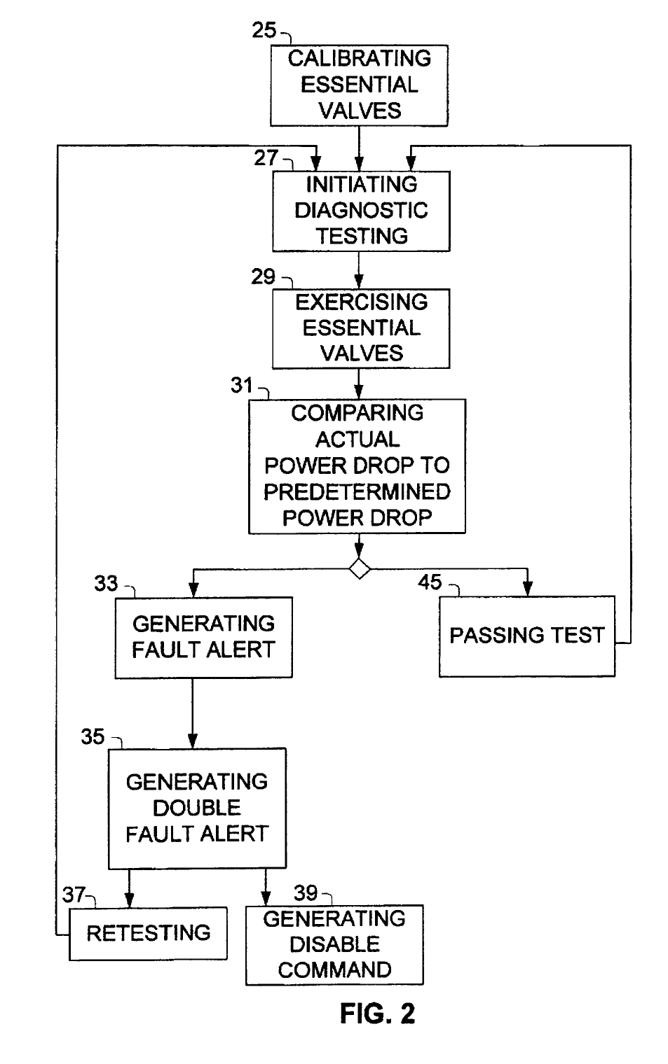

FIG. 2 is a flow chart of a diagnostic method for determining the operability of an essential turbine valve, according to an example of one embodiment of the present invention.

### SIMILAR REFERENCE CHARACTERS REFER TO SIMILAR COMPONENTS

FIG. 1 schematically illustrates a diagnostic system generally designated by numeral 10, according to one embodiment of the present invention, for determining the operability of an essential turbine valve, such as an injection valve or a main open/close valve.

The mass flow rate of the pressurized motive fluid introduced to turbine 5 is regulated by means of one or more injection valves 15, in response to an instantaneous load so that an optimal amount of power will be produced by means of turbine 5 and electric generator 7 coupled thereto. Turbine 5 may be an organic vapor turbine, or alternatively, may be a steam turbine, depending on the type of motive fluid that circulates through the fluid circuit of a power plant and the selected thermodynamic cycle for producing power, and may comprise one or more stages. In a typical Rankine thermodynamic cycle, for example (see FIG. 1A, showing an example of an embodiment of the present invention in such a Rankine cycle power plant) a liquid motive fluid is converted by means of a vaporizer to vapor at high temperature and pressure. The motive fluid vapor is expanded by turbine 5A to produce power, using e.g. electric generator 7A, and is condensed into the liquid phase by means of a condenser 9A. The liquid motive fluid produced thereby is delivered at an increased pressure to vaporizer 11A by means of a pump. If convenient, when using an organic vapor turbine in e.g. a Rankine cycle power plant or unit, a recuperator (not shown), for capturing heat contained in the organic vapor exiting the turbine prior to be supplied to condenser 9A, and a pre-heater (not shown) can also be used for utilizing low grade heat from the heat source or additional heat source.

Turbine 5 at times has to be tripped when one or more essential power plant components malfunction, as well known to those skilled in the art. A main open/close valve 18 upstream to a corresponding injection valve 15 on turbine inlet conduit or line 21 is actuated by valve controller 20 in order to initiate a turbine tripping event.

In order to prevent damage to the power plant, diagnostic system 10 of the present invention is adapted to exercise each of injection valve 15 and open/close valve 18 for a predetermined relatively short exercising duration, e.g. a fraction of a second, and to monitor the valve operation thereafter during the test period. Diagnostic system 10 determines that a valve needs to be replaced if its response time is substantially different than a predetermined nominal value after having been actuated. As referred to herein, a valve is “exercised” when it is caused to be partially closed and then reopened to a desired percentage of opening, during one or more cycles within a predetermined test period. The targeted percentage of valve closing during the exercising operation is selected such that the overall plant power level produced by turbine 5 and electric generator 7 or turbogenerator is intended to be substantially not affected by the exercising operation, i.e. the corresponding “marginal” power drop of the turbogenerator is less than about 10%, for a very short period of time, in order to advantageously perform a diagnostic valve test while the power plant is producing a close to nominal or maximum power level. For example, a marginal power drop for a turbogenerator having a capacity less than about 9 MW may be approximately 0.5 MW, while a marginal power drop for a turbogenerator having a capacity greater than about 9 MW may be approximately 1 MW.

As shown, diagnostic system 10 comprises a computer 22 in data communication with a sensor 12 for detecting the power output of electric generator 7 and with valve controller 20 for controlling and monitoring the operation of an essential valve. Valve controller 20, which may be of the analog or of the discrete type, is generally in data communication with the actuator of the essential valve, e.g. actuator 16 of injection valve 15 and actuator 19 of open/close valve 18. Computer 22 sends control signals to controller 20 when, and under which conditions, to initiate an exercising operation. Controller 20 is able to monitor the actual response time of the essential valve. Output sensor 12 transmits data to computer 22 related to the drop in power output of the turbogenerator in response to an exercising operation.

As shown in FIG. 2, prior to operating the power plant at full capacity, i.e. during startup, the test parameters are calibrated in step 25 by determining a nominal response time for the essential valves in response to an exercising operation until achieving a predetermined marginal drop in the power output produced by the turbogenerator. The diagnostic valve test may be automatically initiated in step 27 according to a predetermined sequence. The automatic diagnostic test may be conducted for example often once a week or even once a day. Alternatively, the valve test may be manually initiated by an operator at a selected time. The valve test is usually conducted only if the given power output of the turbogenerator has been greater than about 10% of its nominal power output for a period of e.g. about one hour, in order to increase the accuracy of the test results and to minimize power drop.

During the diagnostic test, an essential valve is exercised by means of the valve controller in step 29 for a predetermined exercising duration. The predetermined exercising duration may be fairly well equal to the nominal response time; however, it should not exceed a predetermined valve response time which leads to about a 35% drop in nominal power. The actual power drop experienced by the turbogenerator in response to the exercising operation is compared to the predetermined marginal power drop in step 31. A fault alert is generated in step 33 during the occurrence of one of two events: (a) the actual power drop is less than a minimum predetermined power drop, indicating that the response time of the essential valve is excessively slow, or (b) the actual power drop exceeds the marginal power drop by more than a predetermined difference, e.g. greater than about 35%, indicating that the valve failed to respond to the control signal to reopen.

The computer sets the status of the essential valve to an operable status in step 45 if a fault alert was not generated upon completion of the diagnostic test, indicating that the essential valve has successfully passed the test and that its response time is fairly well equal to the nominal response time. The operable valve will therefore be able to reliably regulate the flow of motive fluid therethrough, as controlled by the power plant control system. After a period of time, another diagnostic test for the operable valve will be initiated in step 27, as determined by a predetermined test sequence.

A valve that is indicated as having failed the diagnostic test is retested according to the predetermined sequence, for example, once a day. The computer has a counter module which is adapted to count the number of fault alerts that have been generated for a given essential valve. If and when the counter module indicates that the number of fault alerts that have been generated is greater than a predetermined value, an indication of valve replacement is registered.

After a predetermined time following completion of the diagnostic test for one essential valve, a diagnostic test for a second essential valve operatively connected to a common turbine inlet conduit or line is conducted. A double fault alert is generated in step 35 if an alert fault has been generated for each of the two essential valves operatively connected to the common turbine inlet conduit or line, indicating that there exists a significant risk that at least one of said two essential valves suffers from unreliable operation and that the turbine will not be able to operate at optimal conditions, or that power plant damage is liable to result from the faulty response time of at least one of these two essential valves. Thereafter, the two valves that are indicated as having been subjected to a double fault alert are then retested in step 37 according to a predetermined intensive sequence, e.g. about once every 10 minutes. A disable command is generated for those two valves in step 39, whereby they will be actuated to a closed position within a predetermined period of time following generation of the disable command, if the double fault alert is generated after two subsequent tests consecutively.

This method is repeated for each turbine inlet branch, conduit or line to which essential valves are operatively connected. Prior to conducting the diagnostic test with respect to the essential valves associated with a given branch, conduit or line, the essential valves associated with the other branches are closed. The test is then repeated for the other branch, conduit or line wherein one set of valves is exercised while the other valves are closed.

It is to be emphasized that the present invention described herein can be used with analogue or discrete valves as well as with analogue or discrete valve controls.

While the above description refers to an essential turbine valve or valves, such as an injection valve or a main open/close valve of an organic vapor turbine or steam turbine e.g. an organic vapor turbine or steam turbine operating in a Rankine cycle power plant or unit, the present invention can also be used in association with other power plant systems such as a gas turbine operating according to the Brayton cycle. Moreover, the present invention can be used in systems or processes wherein a small, measurable change in the process, brought about by e.g. the partial closing of a valve, is caused to occur for a very short period of time such that pretty well the process continues to produce its nominal output. Such processes can include production of electric power, torque, flow rate, pressure, etc.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A diagnostic method for determining the operability of an essential turbine valve, comprising the steps of:
a) exercising an essential valve operatively connected to a turbine inlet line through which a power plant motive fluid is supplied to a turbine by causing said essential valve to be partially closed for a predetermined exercising duration;
b) detecting a drop in power produced by an electric generator coupled to said turbine resulting from said partial closing of said essential valve;
c) comparing said detected power drop with a predetermined marginal power drop; and
d) associating said essential valve with an operable status for reliably regulating the flow of motive fluid therethrough when said actual power drop is substantially equal to said predetermined marginal power drop.

2. The method according to claim 1, wherein the exercising duration is substantially equal to a nominal response time measured during a calibration operation from commencement of an exercising operation until detection of the marginal power drop.

3. The method according to claim 2, wherein the marginal power drop is less than 25% of an initial power level produced by the electric generator prior to commencement of the calibration associated exercising operation.

4. The method according to claim 1, wherein the essential valve having an operable status undergoes an additional weekly diagnostic test.

5. The method according to claim 1, wherein an essential valve that has failed a diagnostic test is associated with a fault status and undergoes a daily diagnostic test.

6. The method according to claim 5, wherein the status of an essential valve is set to a fault status when the actual power drop is less than a predetermined minimum power drop.

7. The method according to claim 5, wherein the status of an essential valve is set to a fault status when the actual power drop exceeds the marginal power drop by more than a predetermined difference.

8. The method according to claim 7, wherein the predetermined difference is approximately 10%.

9. The method according to claim 5, wherein an essential valve that has failed a diagnostic test is associated with a double fault status after said essential valve and another essential valve both of which are operatively connected to a common turbine inlet conduit have failed a diagnostic test, said valve associated with a double fault status being required to undergo a predetermined intensive sequence of diagnostic tests.

10. The method according to claim 9, wherein the intensive sequence is a sequence of diagnostic tests taking place approximately every 10 minutes.

11. The method according to claim 10, wherein the valve associated with a double fault status is disabled if it is associated with a double fault status after two subsequent consecutive tests.

12. The method according to claim 4, wherein the diagnostic test is repeated for each turbine inlet branch to which essential valves are operatively connected.

13. The method according to claim 12, wherein the essential valves associated with a first branch are closed prior to conducting the diagnostic test with respect to the essential valves associated with a second branch.

14. A diagnostic system for determining the operability of an essential turbine valve, comprising an essential valve operatively connected to a turbine inlet line through which a power plant motive fluid is supplied to a turbine, a valve controller in electric communication with an actuator of said essential valve, a sensor for detecting the power output of an electric generator coupled to said turbine, and a computing device in data communication with said sensor and with said controller, wherein said computing device is operable to send control signals to said controller to initiate an exercising operation with respect to said essential valve which induces a drop in power produced by said electric generator, to compare data received from said sensor related to an actual power drop induced by said exercising operation with a predetermined marginal power drop, and to associate said essential valve with an operable status for reliably regulating the flow of motive fluid therethrough when said actual power drop is substantially equal to said predetermined marginal power drop.

15. The system according to claim 14, wherein the essential valve is an injection valve.

16. The system according to claim 15, wherein the essential valve is a main open/close valve.
